(19) United States
(12) Patent Application Publication
(10) Pub. No.: US 2014/0089091 A1
(43) Pub. Date: Mar. 27, 2014

(54) Intelligent Advertising System

(71) Applicants: James McBride Kramer, Wayne, NJ (US); Josh Epstein Kaufman, Wayne, NJ (US); Jason MIchael Rosenberg, Wayne, NJ (US); Bryan Barnett Mason, West Orange, NJ (US)

(72) Inventors: James McBride Kramer, Wayne, NJ (US); Josh Epstein Kaufman, Wayne, NJ (US); Jason MIchael Rosenberg, Wayne, NJ (US); Bryan Barnett Mason, West Orange, NJ (US)

(21) Appl. No.: 13/667,748

(22) Filed: Nov. 2, 2012

Related U.S. Application Data
(63) Continuation-in-part of application No. 13/624,748, filed on Sep. 21, 2012, now abandoned.

(51) Int. Cl. G06Q 30/02

(52) U.S. Cl. 705/14.58

(57) ABSTRACT

Disclosed herein are devices for delivering targeted messages to users in conjunction with data about a given user's planned activities. Detailed information on various example embodiments of the inventions are provided in the Detailed Description below, and the inventions are defined by the appended claims.

### CLAIM OF PRIORITY

This filing is a continuation in part of patent application Ser. No. 13/624,748 filed on Sep. 21, 2012 with which it shares inventorship and whose disclosure is incorporated by reference herein in its entirety.

### BACKGROUND/FIELD

It is often the case that electronic messaging in general and advertising in particular is more effective at achieving its goals when said messaging is relevant and timely to the recipient.

Methods and devices are disclosed herein for messaging having improved relevance.

### SUMMARY

According to certain embodiments of the present disclosure, an intelligent advertising system is a method operable on a computer system comprising the steps of; receiving data regarding at least one of the time, place, and nature of a service which a client wishes to receive including for instance a restaurant reservation or haircut appointment; delivering to the user upon a computer display messaging whose relevance is determined and weighted by geographic proximity of the reservation.

According to additional embodiments of the present disclosure, the method further comprises delivering the targeted messaging at a pre-determined time delay of up to 30 days after the service was scheduled to have been delivered.

According to additional embodiments of the present disclosure, the method further comprises delivering the targeted messaging at a pre-determined interval up to 30 days ahead of the reservation.

According to additional embodiments of the present disclosure, the relevance of the messaging is further determined by comparing the subject matter of the messaging with a record of the past activities of the client.

According to additional embodiments of the present disclosure, the relevance of the messaging is further determined by comparing the subject matter of the messaging with information about the client received from a third-party system including for instance an API such as Facebook® or Google®.

According to additional embodiments of the present disclosure, the relevance of the messaging is determined based on the amount of fees paid by a party requesting the messaging.

According to additional embodiments of the present disclosure, the relevance of the messaging is determined by the nature of the service which the client is about to receive.

According to additional embodiments of the present disclosure, the messaging is delivered to the client onto a mobile device such as a tablet, pager or cellular telephone.

According to additional embodiments of the present disclosure, the messaging delivered to the client via a third-party internet advertising network including for instance Google Adwords®, Facebook Ads®, or Bing® Ads.

According to additional embodiments of the present disclosure, a method for delivering targeted messaging to a user being operable on a computer is disclosed, the method comprising the steps of; receiving data regarding at least one of the time, place, and nature of a service which a client wishes to receive including for instance a restaurant reservation or haircut appointment; delivering to the user upon a computer display messaging whose relevance is determined and weighted by type of service to be received by the client.

According to additional embodiments of the present disclosure, the method further comprises delivering the targeted messaging at a pre-determined time delay of up to 30 days after the service was scheduled to have been delivered.

According to additional embodiments of the present disclosure, the method further comprises delivering the targeted messaging at a pre-determined interval up to 30 days ahead of the reservation.

According to additional embodiments of the present disclosure, the relevance of the messaging is further determined by comparing the subject matter of the messaging with a record of the past activities of the client.

According to additional embodiments of the present disclosure, the relevance of the messaging is further determined by comparing the subject matter of the messaging with information about the client received from a third-party system including for instance an API such as Facebook® or Google®.

According to additional embodiments of the present disclosure, the relevance of the messaging is determined based on the amount of fees paid by a party requesting the messaging.

According to additional embodiments of the present disclosure, the messaging is delivered to the client onto a mobile device such as a tablet, pager or cellular telephone.

According to additional embodiments of the present disclosure, the messaging delivered to the client via a third-party internet advertising network including for instance Google Adwords®, Facebook Ads®, or Bing® Ads.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

FIG. 1 shows a logic flow chart of a message being entered and routed through the system.

FIG. 2 shows a logic flow chart of a patron redeeming an offer.

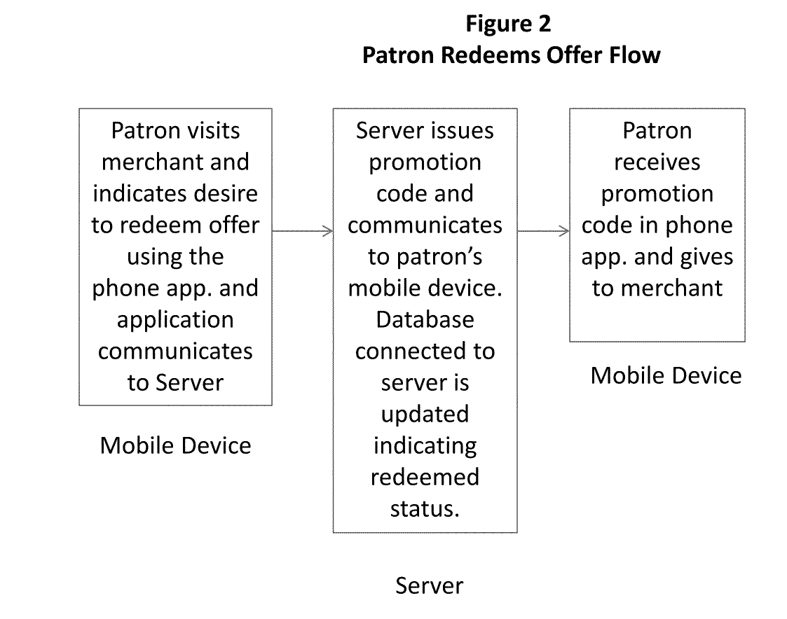

FIG. 3 shows a mockup of a merchant interface for displaying an offer.

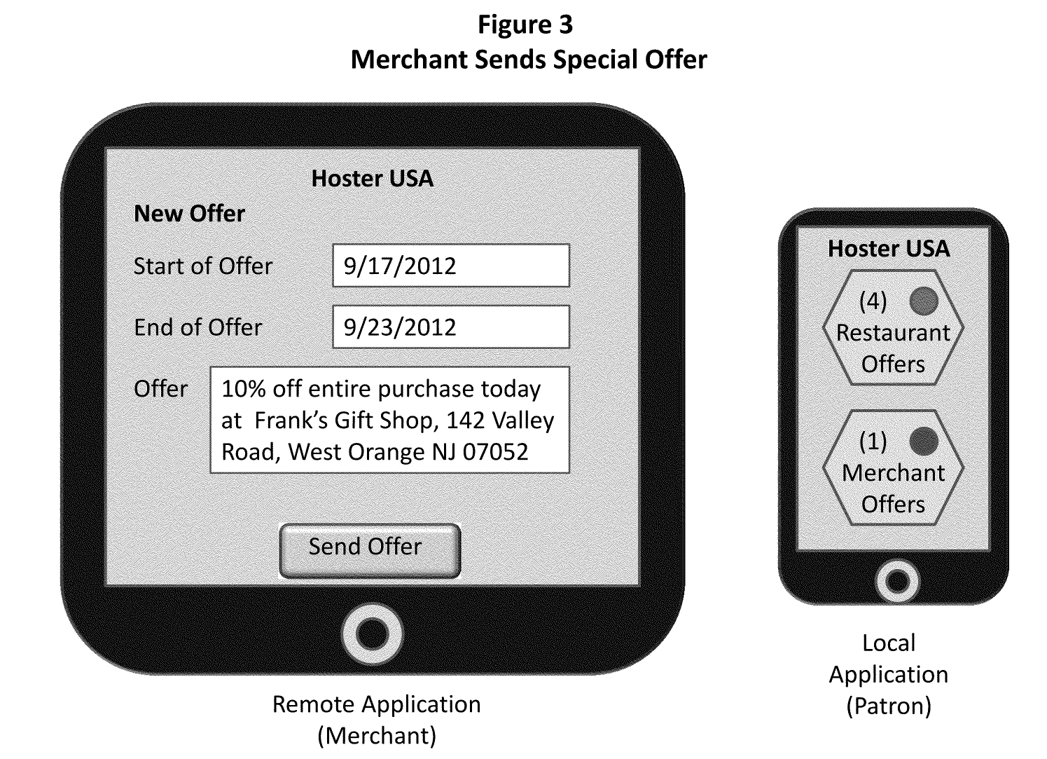

FIG. 4 shows user interfaces for redeeming an offer.

### DETAILED DESCRIPTION OF SELECTED EMBODIMENTS OF THE PRESENT DISCLOSURE

In the specification that follows, the terms “remote” and “local” are used relative to a user, meaning that the device in use by a user; be it a portable computing device of stationary computer is local, while the functionalities and devices that are disposed away from the user, such as a server or terminal are referred to as “remote.” Further the terms messaging and advertising are here used interchangeably to refer to content which a 3rd parties wishes to display upon a local device.

A system for delivering targeted messaging includes a computer server for managing requests, a remote application accessible to a merchant for configuring messages in electronic communication with the server, and a local computing device capable of displaying messaging to the user. The remote and local computers are configured to record a service request by the user, including for instance a restaurant reservation, doctor's appointment, or automotive transmission service. Service requests are stored with descriptive data regarding the service. This may include at least one of, the location of the service, the time and date of the service, the type of service being received, the frequency or the service requests by the user, and the user's history of previous service requests. The local device also has the capability of receiving and displaying messages/advertisements thereon via either a native application, website, sms or other messaging system.

Additionally, certain embodiments of the present disclosure include the capacity to record, store and utilize demographic, social, economic, and interests data about the user retrieved directly from the user or from third-party information sources such as Facebook®, LinkedIn®, Amazon®, Google® or other sources store user-specific information and make it available to third parties from time to time.

Examples of demographic data include for instance information regarding age, sex, education, profession, residence, citizenship, languages spoken, as well as family and relationship status. Examples of social data include for instance social or professional connections, membership in social or professional organizations, activity levels within respective social networking communities, standing and authority levels within said communities.

Examples of economic data include for instance purchase habits and history in online as well as brick-and-mortar stores, income levels for the profession practiced by the user, income levels for the area immediately surrounding the user's residence, cookies or other unique identifiers present on the users' local device. Examples of interests data include for instance hobbies and activities, online reading habits, or nature of previous service requests.

The messages may be static notifications, including for instance description of sale items or announcements of store openings. Conversely, the message may be offers capable of being accepted or acted upon by the user, such as coupon codes or rewards for actions performed by the user within social media platforms.

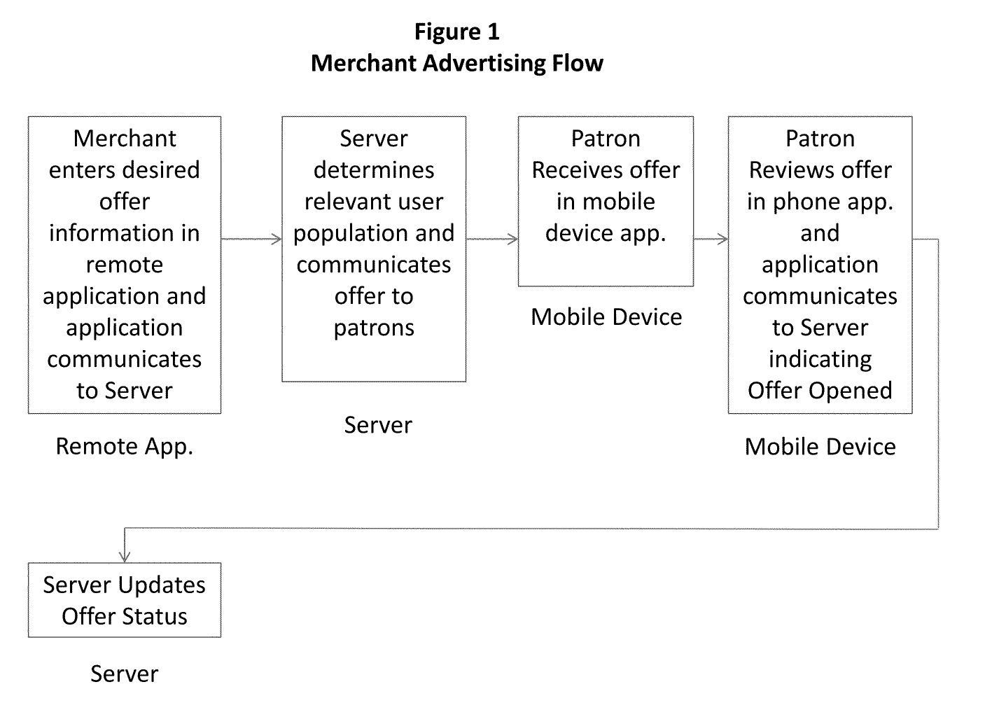

Further, the remote systems are capable of receiving, storing, and organizing a plurality of messages or offers intended for user(s) as shown for instance in FIG. 1. When such messages are created by a merchant, the merchant may determine, via a user interface which of the aforementioned data about a user or his activities increase or decrease relevance to the message at hand.

Upon receipt of a plurality of messages intended for a user on a local device from merchants, the system must determine which messages to display and when to display them. Herein lays the determining step described in FIG. 1. The determination step involves comparing information about the message with information about the user and his activities. The output of the determination step is the selection of which messages, from among those capable of being displayed to a user will in fact be shown. This determination step may occur in either the local or remote computers and proceeds by comparing the data known about the user and the relevance information entered by the merchant.

An exemplary process of using the system and method claimed herein will now be described. A first merchant is a restaurateur in a shopping mall whose message is an offer for 20% discount on food to the first 20 customers every lunch time. The merchant enters his message into the server and mark it as being geographically relevant to users within the same shopping mall with a time window of 30 minutes. A second merchant is a pharmacy within the shopping mall which is having a sale on a certain brand of premium shampoo. A third merchant is a barbershop in the same mall whose message is a grand-opening announcement.

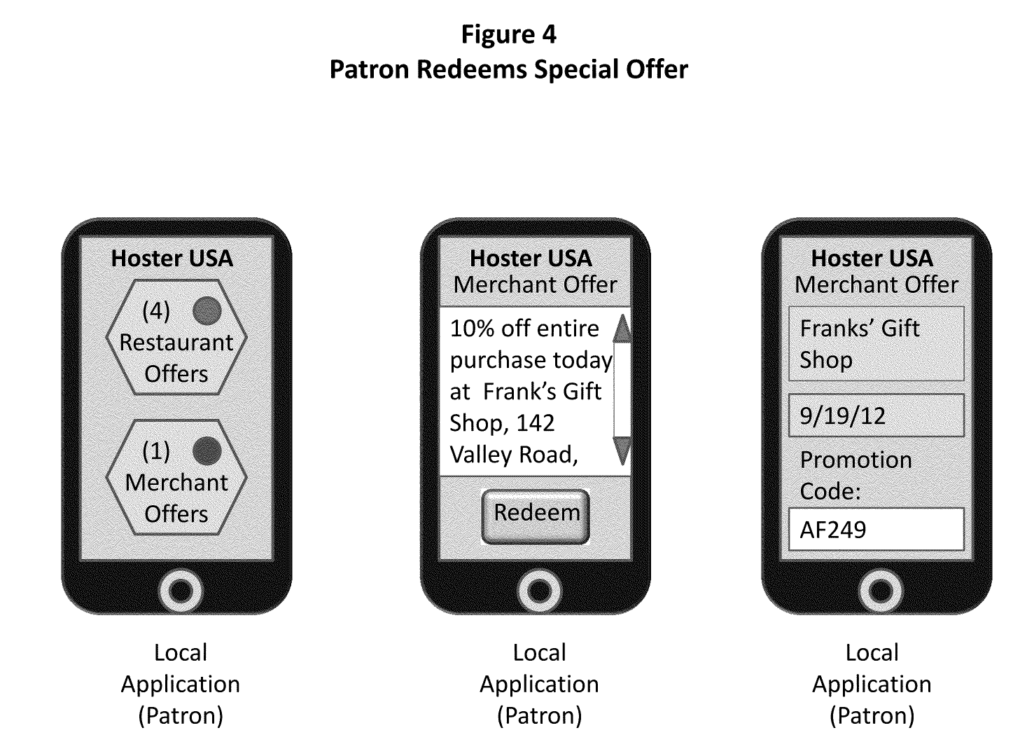

When a user makes an appointment to receive a service within the mall, including for instance a haircut on Monday at 11:30 AM, information about the time, location, and nature of that service will be sent to the server. The user's credentials within the server are connected to the user's Facebook account which allows the server to determine that the user is a married male in his early 30s along with other demographic information. The server then compares the time, location, and nature of the pending service and the demographic information with the advertisements and messages previously entered by advertisers and merchants to determine which messages are relevant to the user. Consequently, both 30 minutes before and 30 minutes after the scheduled appointment, the local device will actively display the first merchant's offer to the user and give the user and where appropriate, give the user the ability to redeem the offer as shown in FIG. 4. Similarly, if the third merchant marketed his demographic target as men over the age of 25, then the server will consider those messages as having increased relevance as well.

While an intelligent advertising system has been described and illustrated in conjunction with a number of specific configurations and methods, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

What is claimed is:

1. A method for delivering targeted messaging to a user being operable on a computer, the method comprising the steps of;
a. receiving data regarding at least one of the time, place, and nature of a service which a client wishes to receive including for instance a restaurant reservation or haircut appointment;
b. delivering to the user upon a computer display messaging whose relevance is determined and weighted by geographic proximity of the reservation.

2. The method of claim 1, the method further comprising delivering the targeted messaging at a pre-determined time delay of up to 30 days after the service was scheduled to have been delivered.

3. The method of claim 1, the method further comprising delivering the targeted messaging at a pre-determined interval up to 30 days ahead of the reservation.

4. The method of claim 1, wherein the relevance of the messaging is further determined by comparing the subject matter of the messaging with a record of the past activities of the client.

5. The method of claim 1, wherein the relevance of the messaging is further determined by comparing the subject matter of the messaging with information about the client received from a third-party system including for instance an API such as Facebook® or Google®.

6. The method of claim 1, wherein the relevance of the messaging is determined based on the amount of fees paid by a party requesting the messaging.

7. The method of claim 1, wherein the relevance of the messaging is determined by the nature of the service which the client is about to receive.

8. The method of claim 1, wherein the messaging is delivered to the client onto a mobile device such as a tablet, pager or cellular telephone.

9. The method of claim 1, wherein the messaging delivered to the client via a third-party internet advertising network including for instance Google Adwords®, Facebook Ads®, or Bing® Ads.

10. A method for delivering targeted messaging to a user being operable on a computer, the method comprising the steps of;
a. receiving data regarding at least one of the time, place, and nature of a service which a client wishes to receive including for instance a restaurant reservation or haircut appointment;
b. delivering to the user upon a computer display messaging whose relevance is determined and weighted by type of service to be received by the client.

11. The method of claim 10, the method further comprising delivering the targeted messaging at a pre-determined time delay of up to 30 days after the service was scheduled to have been delivered.

12. The method of claim 10, the method further comprising delivering the targeted messaging at a pre-determined interval up to 30 days ahead of the reservation.

13. The method of claim 10, wherein the relevance of the messaging is further determined by comparing the subject matter of the messaging with a record of the past activities of the client.

14. The method of claim 10, wherein the relevance of the messaging is further determined by comparing the subject matter of the messaging with information about the client received from a third-party system including for instance an API such as Facebook® or Google®.

15. The method of claim 10, wherein the relevance of the messaging is determined based on the amount of fees paid by a party requesting the messaging.

16. The method of claim 10, wherein the messaging is delivered to the client onto a mobile device such as a tablet, pager or cellular telephone.

17. The method of claim 10, wherein the messaging delivered to the client via a third-party internet advertising network including for instance Google Adwords®, Facebook Ads®, or Bing® Ads.
